(19) United States
(12) Patent Application Publication
(10) Pub. No.: US 2019/0047368 A1
(43) Pub. Date: Feb. 14, 2019

(54) POSITION ADJUSTABLE RADIANT HEATING ASSEMBLY

(71) Applicant: FORD GLOBAL TECHNOLOGIES, LLC, Dearborn, MI (US)

(72) Inventors: John Craig Elson, Bloomfield Township, MI (US); Clay Wesley Maranville, Ypsilanti, MI (US); Donald P. Schneider, Commerce Twp, MI (US); Manfred Koberstein, Troy, MI (US); Victoria L. Schein, Dearborn, MI (US); Kerrie K. Gath, Pittsfield, MI (US)

(21) Appl. No.: 15/675,430

(22) Filed: Aug. 11, 2017

(51) Int. Cl. B60H 1/22

(52) U.S. Cl. CPC B60H 1/2218; H05B 1/0236; B60H 2001/2243

(57) ABSTRACT

A radiant heating assembly includes a position adjustable mount, a radiant heating element carried on the position adjustable mount and an actuator to displace the radiant heating element between a first position and a second position.

### TECHNICAL FIELD

This document relates generally to the radiant heating field and, more particularly, to a radiant heating assembly that includes a radiant heating element that may be displaced between at least two operating positions by means of one or more position adjustable mounts and one or more actuators in order to provide a rapid and efficient radiant heat to warm individuals such as occupants of a motor vehicle even when that motor vehicle has been sitting overnight in low temperature conditions.

### BACKGROUND

A standard automobile heating, ventilating and air conditioning (HVAC) system heats by circulating air through a heater core where that air is put in a heat exchange relationship with coolant circulated from the motor vehicle engine. After the motor vehicle has been at rest in low temperature conditions for an extended period of time, the engine coolant cools to the ambient temperature and requires a substantial amount of time before it warms sufficiently to provide heat to the air being circulated by the HVAC system. Further, the warmed air must first warm the ducts and blend with all the cold air in the passenger compartment of the motor vehicle before providing a significant warming sensation to the motor vehicle occupants. This delay can lead to occupant dissatisfaction.

Additionally, it should be appreciated that inefficiencies, affecting fuel economy, are currently built into the combustion engines to meet climate targets (e.g. spark retard). These slow the air heating process.

The warming of air in cold situations in electric vehicles requires using some of the motor vehicle travel range to heat the vehicle. Further, while the motor vehicle may be equipped with positive temperature coefficient (PTC) heaters which under many conditions will reach air warming temperatures prior to engine coolant, such heaters still require time to heat the air in the passenger compartment of the motor vehicle.

This document relates to a new and improved radiant heating assembly for a motor vehicle that addresses and solves these issues. That assembly includes a radiant heating element that may be selectively displaced by a user between two or more operating positions by means of one or more position adjustable mounts and one or more actuators. Advantageously, the radiant heating element of the radiant heating assembly may, therefore, be positioned in an orientation that more efficiently and effectively transfers heat in the form of infrared radiation, to an occupant of a motor vehicle or in any other environment.

### SUMMARY

In accordance with the purposes and benefits described herein, a radiant heating assembly is provided. That radiant heating assembly comprises a position adjustable mount, a radiant heating element carried on the position adjustable mount and an actuator. The actuator is utilized to displace the radiant heating element between a first position and a second position.

In at least one possible embodiment of the radiant heating assembly, the position adjustable mount is a hinge. In such an embodiment the actuator may be a linear actuator. Linear actuators is useful in the radiant heating assembly include but are not necessarily limited to screw drives, shape memory alloy (SMA) actuators, dielectric elastomers, solenoid actuators, kinematic linkage assemblies actuated by solenoids, pneumatic actuators and hydraulic actuators. In some embodiments the actuator may be incorporated into the hinge.

In at least one of the many possible embodiments of the radiant heating assembly, the radiant heating assembly may include a biasing element that biases the radiant heating element toward the first position. In such an embodiment the biasing element would be provided on a first side of the hinge while the actuator would be provided on a second side of the hinge. In other embodiments, the biasing element may be incorporated into the hinge.

In at least one of the many possible embodiments, the position adjustable mount may be a ball joint. In such an embodiment the actuator may include a first actuator and a second actuator. The first actuator may be connected to the radiant heating element at one connection point while the second actuator may be connected to the radiant heating element at another connection point remote from the first connection point.

In at least one possible embodiment the radiant heating assembly may further include a first biasing element and a second biasing element. The first biasing element, the ball joint and the first actuator may be aligned so as to define a first axis about which the radiant heating element may be pivoted while the second biasing element, the ball joint and the second actuator may define a second axis about which the radiant heating element may be pivoted. In such an embodiment the first axis may be provided perpendicular to the second axis. In such embodiments the first actuator and the second actuator may both be selected from a group consisting of a linear actuator, a cable and pulley, a hydraulic actuator, a pneumatic actuator, a screw drive, shape memory alloy (SMA) actuators, dielectric elastomers, solenoid actuators, kinematic linkage assemblies actuated by solenoids and combinations thereof.

In at least one possible embodiment of the radiant heating assembly, the position adjustable mount may be a first guide track. In such an embodiment the actuator may comprise a motor or a linear actuator. Further, in some embodiments the radiant heating assembly may further include a biasing element biasing the radiant heating element toward the first position.

Still further, various embodiments of the radiant heating assembly may include multiple position adjustable mounts and multiple actuators. In such embodiments the radiant heating assembly may further include a carriage that rides along the first guide track. Further, a second position adjustable mount may be provided on the carriage so as to be displaceable along the first guide track with the carriage. Further, a second actuator may also be provided on the carriage so as to be displaceable along the first guide track with the carriage. Together, the first actuator and second actuator function to displace the radiant heating element between the first position and the second position.

In these embodiments, the second position adjustable mount may be a second guide track extending aparallel to the first guide track and the second actuator displaces the radiant heating element along the second guide track. In some of these embodiments the second position adjustable mount is a hinge and the second actuator displaces the radiant heating element about that hinge. In some of these possible embodiments, the second position adjustable mount is a ball joint and the second actuator displaces the radiant heating element about that ball joint.

In any of the possible embodiments of radiant heating assembly, the radiant heating element may comprise a radiant heating panel or a specular radiant heating surface that may, for example, be adapted to reflect infrared radiation from a radiant heating panel toward another specular radiant heating surface or an occupant or object to be heated with infrared radiation.

In the following description, there are shown and described several preferred embodiments of the radiant heating assembly. As it should be realized, the radiant heating assembly is capable of other, different embodiments and its several details are capable of modification in various, obvious aspects all without departing from the radiant heating assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the radiant heating assembly and together with the description serve to explain certain principles thereof.

FIG. 1 is a schematic illustration of a first possible embodiment of radiant heating assembly wherein the position adjustable mount is a pivot or hinge and the actuator is a linear actuator.

FIG. 2 is a schematic illustration of a second possible embodiment of a radiant heating assembly wherein the position adjustable mount is a pivot or hinge, the actuator is a pulley and cable device and a biasing element is provided on the opposite side of the pivot or hinge from the actuator.

FIGS. 3a and 3b are respective schematic side elevational and top plan views illustrating yet another possible embodiment of radiant heating assembly including a position adjustable mount, in the form of a ball joint, and two linear actuators.

FIGS. 4a and 4b are respective schematic side elevational and top plan views of yet another possible embodiment of radiant heating assembly including a position adjustable mount, in the form of a ball joint, two actuators in the form of two cable and pulley devices and two springs opposite those two actuators.

FIG. 5a illustrates yet another possible embodiment of radiant heating assembly wherein a position adjustable mount is a guide track and the actuator is a motor driving pinions that roll along the two racks of the guide track.

FIG. 5b is a schematic view of yet another possible embodiment of radiant heating assembly wherein the radiant heating element is displaced between two or more positions by means of a position adjustable mount in the form of a guide track and an actuator in the form of a linear actuator.

FIG. 5c is a schematic illustration of yet another possible embodiment of radiant heating assembly wherein the radiant heating element is displaced between two or more operating positions by means of a position adjustable mount in the form of a guide track, an actuator in the form of a pulley and cable device and a biasing element that functions to bias the heating element into a first operating position.

FIG. 6 is a schematic block diagram of yet another possible embodiment wherein the radiant heating assembly incorporates two position adjustable mounts and two actuators for displacing the radiant heating element between operating positions.

FIG. 7 is a schematic view of one possible configuration of the embodiment illustrated in FIG. 6 which includes a first actuator (in the form of a motor), a first position adjustable mount in the form of a guide track, a carriage that is displaced along that guide track, a second guide track carried on the carriage and a second actuator (also in the form of a motor) for displacing the heating element along that second guide track.

FIG. 8 is a schematic view of two radiant heating assemblies provided on the instrument panel of a motor vehicle.

Reference will now be made in detail to the present preferred embodiments of the radiant heating assembly, examples of which are illustrated in the accompanying drawing figures.

### DETAILED DESCRIPTION

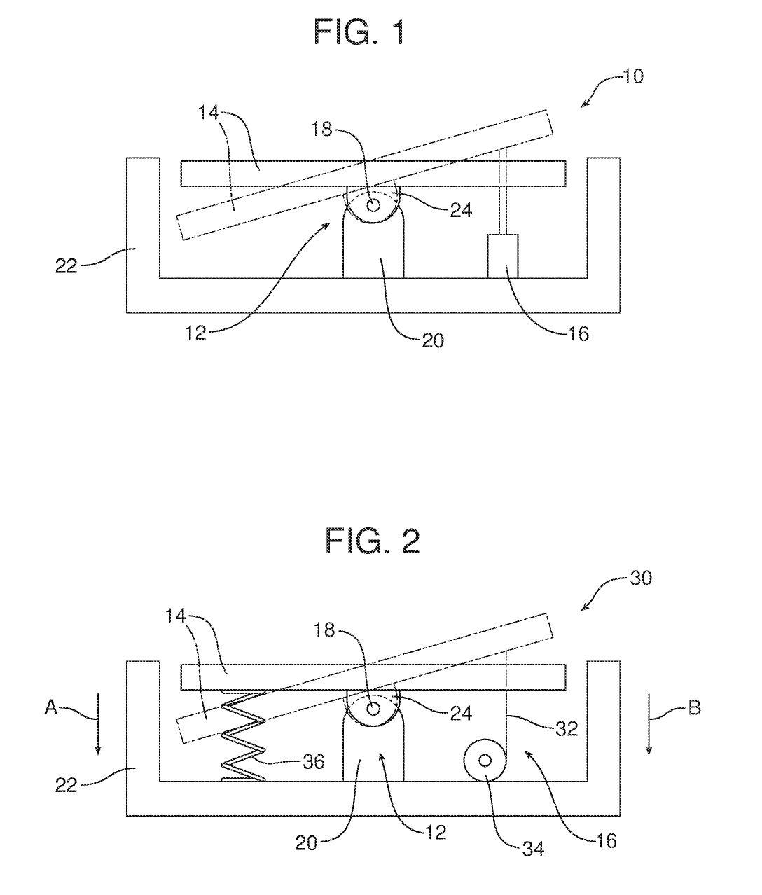

Reference is now made to FIG. 1 which schematically illustrates a first possible embodiment of radiant heating assembly 10. That radiant heating assembly 10 includes a position adjustable mount 12, a radiant heating element 14 and an actuator 16 to displace the radiant heating element between a first position (indicated in full line) and a second position (indicated in phantom line).

In this FIG. 1 embodiment, the position adjustable mount comprises a hinge pin 18 passing through an aperture (not shown) in the lug 20 within the housing 22 and aligned apertures in the clevis 24 provided on the back side of the support structure for the radiant heating element 14. In the embodiment illustrated in FIG. 1, the actuator 16 is a linear actuator which may take the form of a hydraulic actuator, a pneumatic actuator or a screw drive.

The housing 22 may be made from a thermal insulating material. If desired, a cover or guard (not shown) of IR transparent material may be provided over the open end of the housing to prevent one from touching the radiant heating element 14. An air gap or vacuum gap may be provided between that guard and the radiant heating element 14 if desired. In addition, it should be appreciated that the radiant heating element 14 may comprise a radiant heating panel of the type that generates heat by generating infrared radiation or a specular radiant heating surface of a type that reflects infrared radiation from a source of infrared radiation such as an IR heating panel or another specular radiant heating surface to an object to be heated or another specular heating surface.

Reference is now made to FIG. 2 illustrating another possible embodiment of radiant heating assembly 30. The radiant heating assembly 30 is similar to the radiant heating assembly 10 illustrated in FIG. 1 in that it incorporates a position adjustable mount 12, including a hinge pin 18 that engages in a lug 20 on the housing 22 and a clevis 24 on the radiant heating element 14. However, in contrast to the radiant heating assembly 10 illustrated in FIG. 1, the radiant heating assembly 30 illustrated in FIG. 2 includes an actuator 16 in the form of a device including a cable 32 and a pulley 34. In addition, the radiant heating assembly includes a biasing element 36. As illustrated in FIG. 2, the biasing element 36 is provided on a first side of the hinge/position adjustable mount 12 while the actuator 16 is provided on a second side thereof.

The biasing element 36 may comprise a compression spring or a tension spring and the pulley 34 may comprise a reel for the cable 32 and a drive motor for rotating the pulley and winding or unwinding the cable. In the embodiment illustrated in FIG. 2, the biasing element 36 is a tension spring that biases the radiant heating element 14 in the direction of action arrow A into the first operative position indicated in phantom line. When the actuator 16 is activated, the pulley 34 winds the cable 32 drawing the opposite end of the radiant heating element 14 in the direction of action arrow B until the radiant heating element is in the second operating position illustrated in full line.

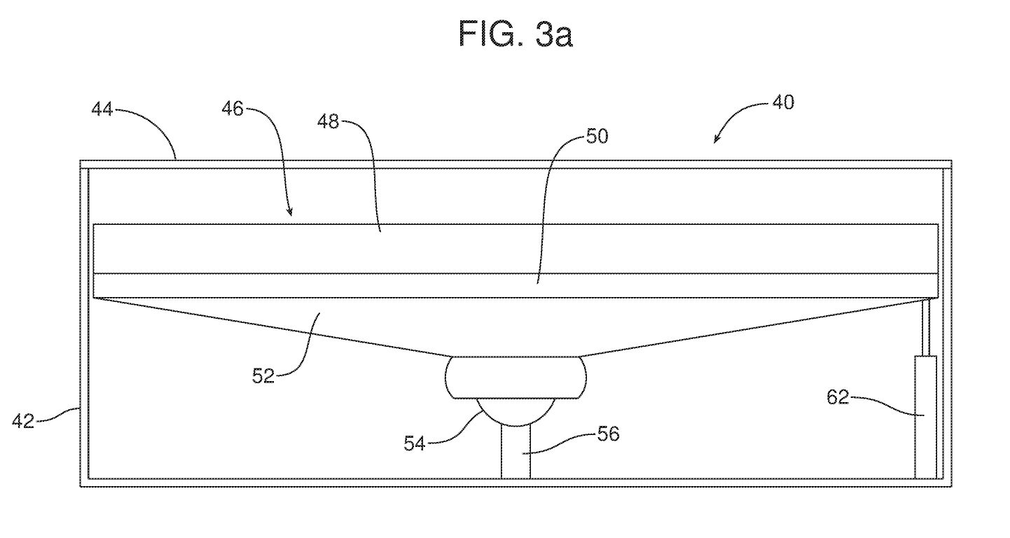

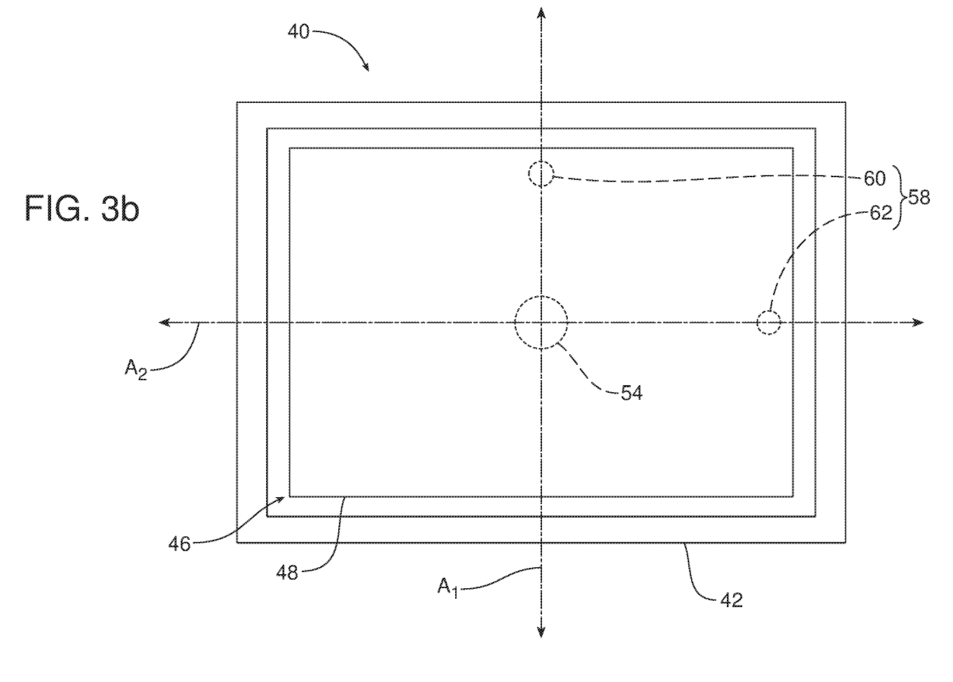

Reference is now made to FIGS. 3a and 3b illustrating yet another possible embodiment of radiant heating assembly 40. As best illustrated in FIG. 3a, the radiant heating assembly 40 includes a housing 42 made of thermal insulating material having an open end covered by an IR transparent guard material 44. The radiant heating element 46 comprises a radiant heating panel 48 backed by a thermal insulating material 50 and supported on a structural support 52. The position adjustable mount 54 comprises a ball joint which is fixed to the housing 42 by the stem 56.

As should be apparent from reviewing FIGS. 3a and 3b in combination, the radiant heating assembly 40 includes an actuator 58 in the form of two separate linear actuators 60, 62. As best illustrated in FIG. 3b, the first linear actuator 60 and the second linear actuator 62 are connected to the structural support 52 of the radiant heating element 46 at two different connection points. A first axis A₁ is defined by a line running through the first connection point/first linear actuator 60 and the ball joint/position adjustable mount 54 while a second axis A₂ is defined by a line running through the second connection point/second linear actuator 62 and the ball joint/position adjustable mount 54. In the illustrated embodiment the first axis A₁ and the second axis A₂ are perpendicular to one another. Accordingly, the two linear actuators 60, 62 may be manipulated to angularly orient the radiant heating element 46 with two degrees of freedom by rotating the radiant heating element 46 on the ball joint/position adjustable mount 54 about the first and second axes A₁, A₂.

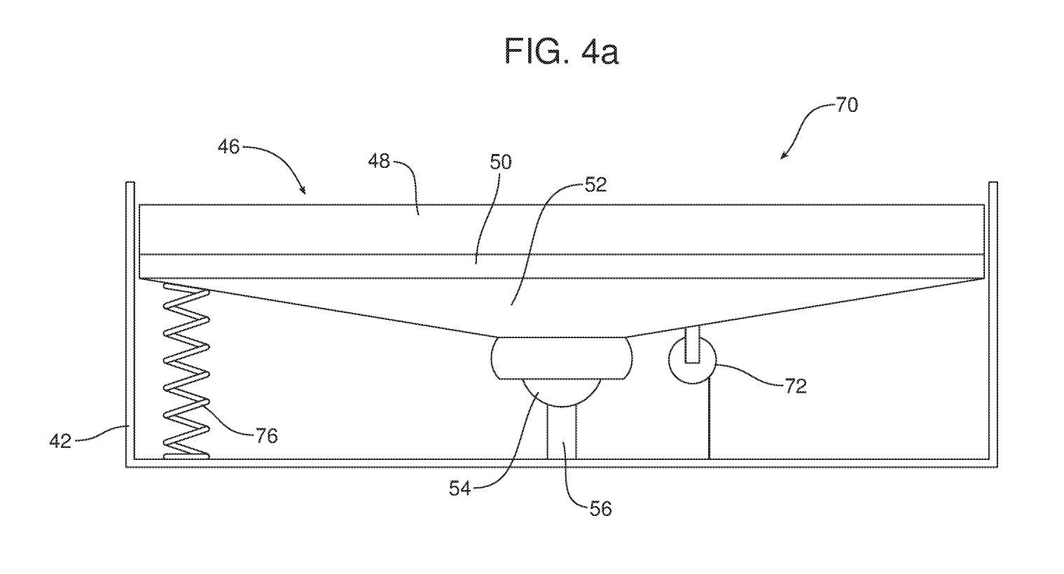

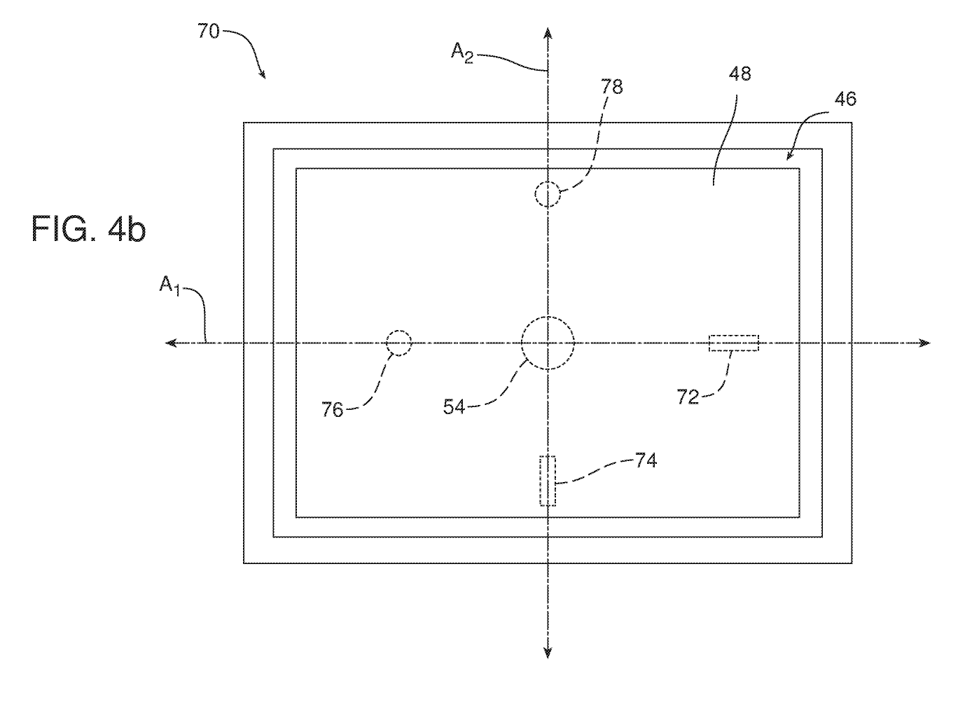

FIGS. 4a and 4b illustrate yet another possible embodiment of radiant heating assembly 70. The radiant heating assembly 70 illustrated in FIGS. 4a and 4b differs from the radiant heating assembly 40 illustrated in FIGS. 3a and 3b by replacing the two linear actuators 60, 62 with two cable and pulley devices 72, 74. In addition, the radiant heating assembly 70 illustrated in FIGS. 4a and 4b includes a first biasing element 76 opposite the first cable and pulley device 72 and a second biasing element 78 opposite the second cable and pulley device 74.

Thus, as illustrated in FIG. 4b, a first axis A₁ runs through the first cable and pulley device 72, the ball joint/position adjustable mount 54 and the first biasing element 76 while a second axis A₂ runs through the second cable and pulley device 74, the ball mount/position adjustable mount and the second biasing element 78.

In the illustrated embodiment, the first biasing element 76 and the second biasing element 78 are both compression springs functioning to bias the radiant heating element 46 into the first operative position. Thus, the first cable and pulley device 72 and second cable and pulley device 74 are activated to pivot the radiant heating element 46 about the first axis A₁ and the second axis A₂ in opposition to the biasing force of the two biasing elements 76, 78 into a second or other operative position.

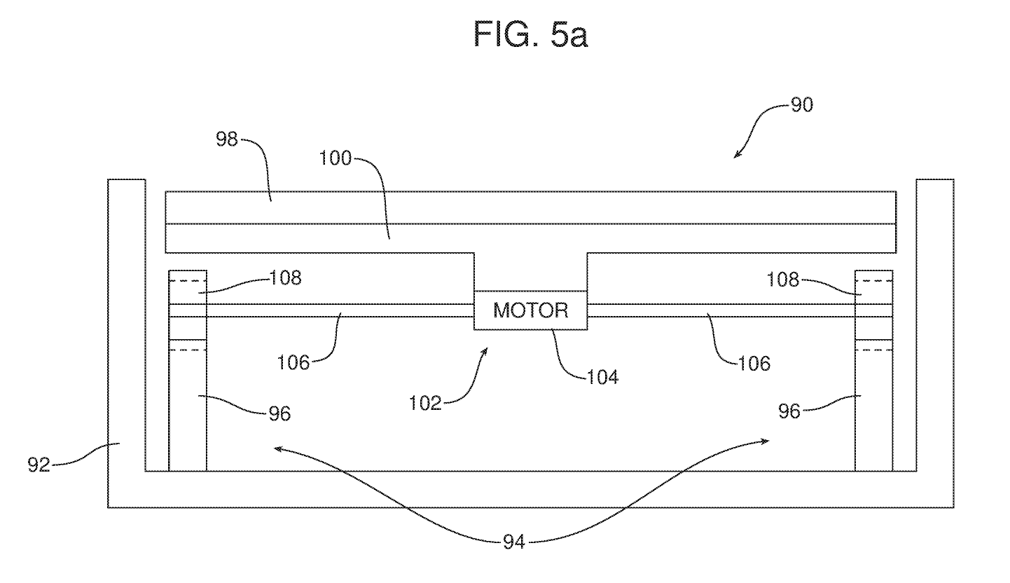

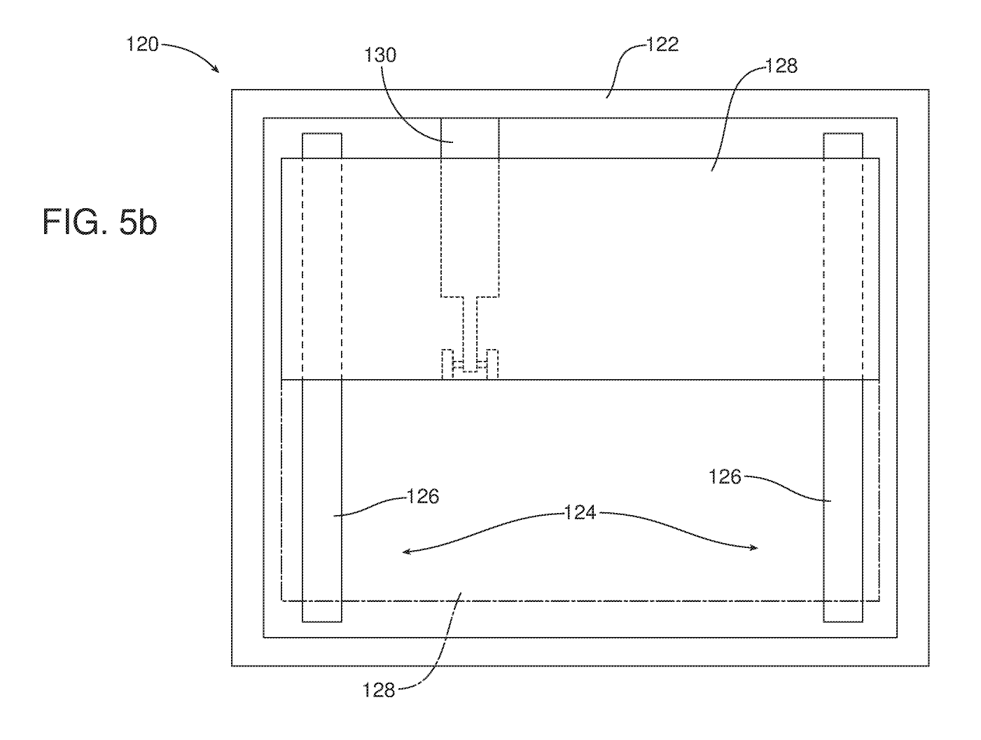

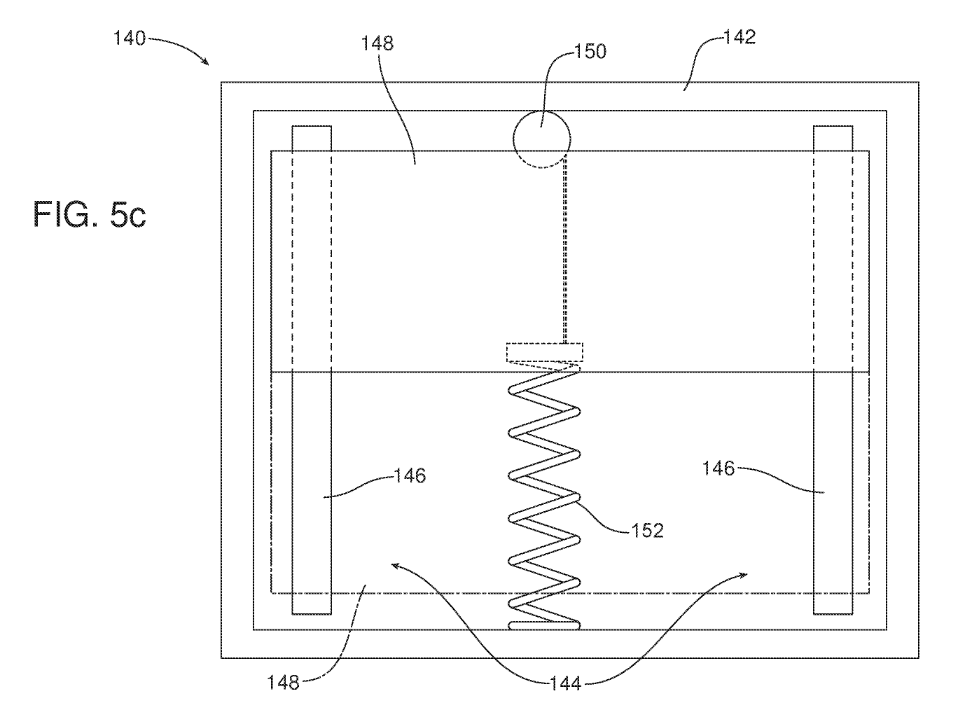

Reference is now made to FIG. 5a illustrating yet another possible embodiment of radiant heating assembly 90. As illustrated in FIG. 5a, the radiant heating assembly 90 includes a housing 92 made from a thermal insulating material. A position adjustable mount 94 is provided in the housing 92. In the illustrated embodiment, the position adjustable mount 94 comprises a guide track formed by two cooperating toothed racks 96.

The radiant heating assembly 90 also includes a radiant heating element 98 supported on a support substrate 100 which is carried on the position adjustable mount 94.

The radiant heating assembly 90 also includes an actuator 102 in the form of a drive motor 104 connected by means of the split drive shaft 106 to two pinions 108 that engage the two tooth racks 96 of the guide track/position adjustable mount 94. Thus, it should be appreciated that the drive motor 104 of the actuator 102 is utilized to displace the radiant heating element 98 between two or more operative positions along the guide track/position adjustable mount 94. This arrangement allows an operator to better position and orient the radiant heating element 98 to efficiently and effectively heat the operator.

Reference is now made to FIG. 5b illustrating yet another possible embodiment of radiant heating assembly 120. That radiant heating assembly 120 includes a housing 122 holding a position adjustable mount 124 in the form of a guide track including two opposed guide rails 126. The radiant heating element 128 rides along the guide track/position adjustable mount 124 and is displaced along the guide track/position adjustable mount by means of an actuator in the form of the linear actuator 130.

Reference is now made to FIG. 5c illustrating yet another possible embodiment of radiant heating assembly 140. The radiant heating assembly 140 includes a housing 142 holding a position adjustable mount 144 in the form of a guide track including two opposed guide rails 146. The radiant heating element 148 of the radiant heating assembly 140 is displaceable along that guide track/position adjustable mount 144 by means of an actuator in the form of cable and pulley device 150 which provides tension acting against the force of the biasing element or tension spring 152. Thus, it should be appreciated that the cable and pulley device 150 is activated to displace the radiant heating element along the guide track/position adjustable mount 144 between two or more operating positions.

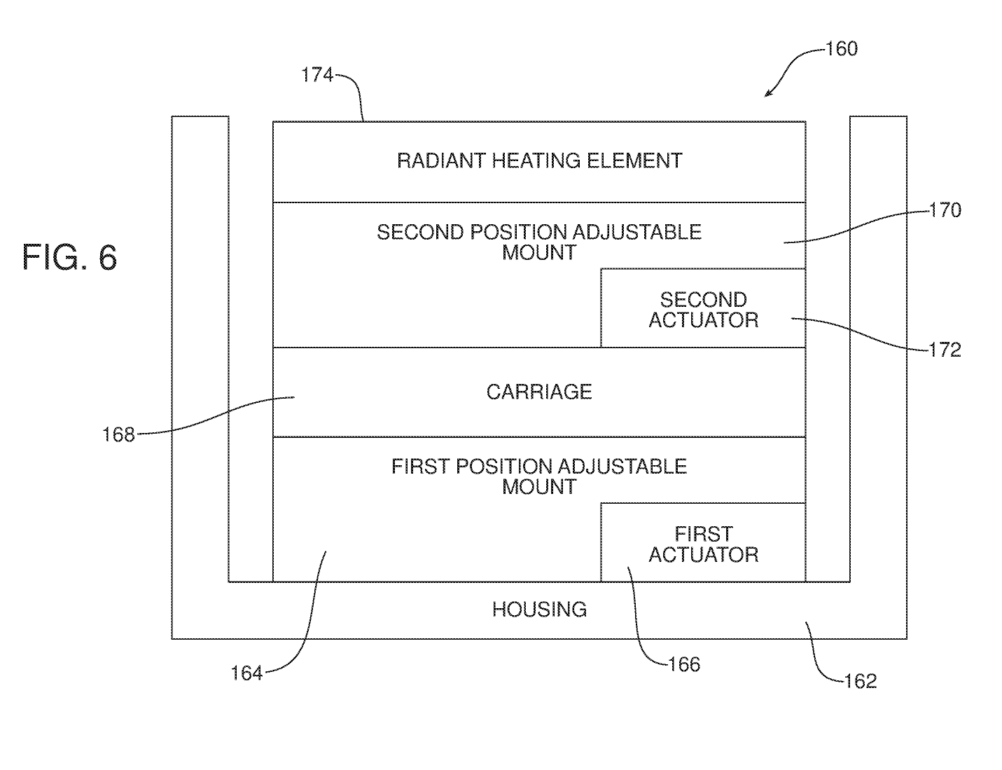

The mechanisms for displacing the radiant heating elements 14, 46, 80, 98, 128, and 148 in the above embodiments may be combined. Thus, as illustrated in FIG. 6, the radiant heating assembly 160 may include a thermal insulating housing 162 supporting a first position adjustable mount 164. A first actuator 166 connected between the first position adjustable mount 164 and the housing 162 or between the first position adjustable mount 164 and the carriage 168 allows for the displacement of the carriage between two or more operating positions. A second position adjustable mount 170 and a second actuator 172 are provided on the carriage 168 and allow for the displacement of the radiant heating element 174 between multiple operating positions on the carriage.

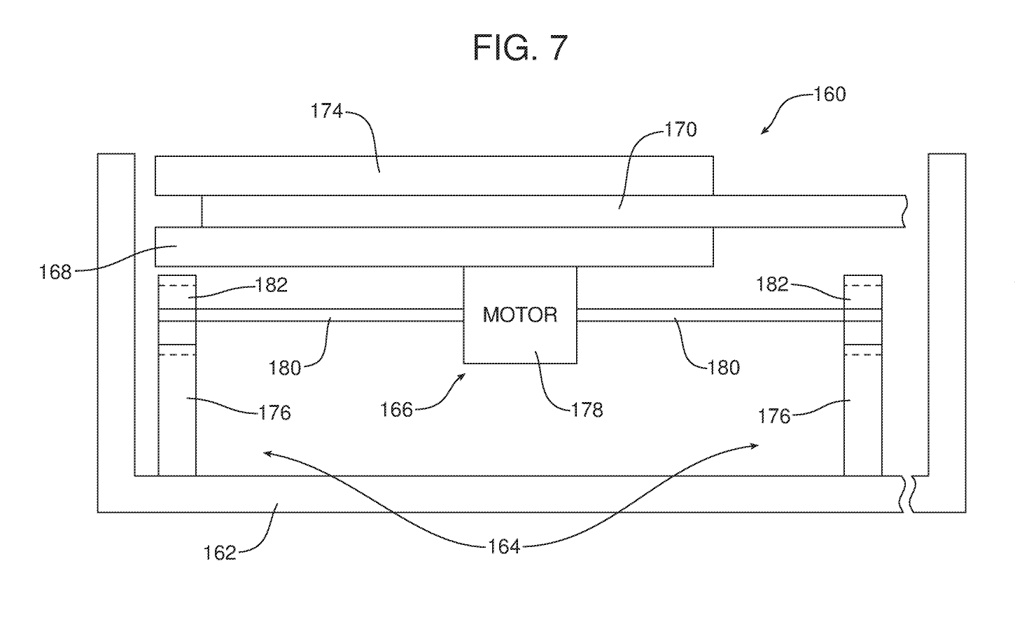

Reference is now made to FIG. 7 illustrating one possible embodiment of the radiant heating assembly 160 schematically illustrated in FIG. 6. As illustrated in FIG. 7, the radiant heating assembly 160 comprises the housing 162 constructed from a thermal insulating material and the first position adjustable mount 164 in the form of a guide track with two toothed guide rails 176. The first actuator 166 comprises a motor 178, cooperating drive shaft 180 and cooperating pinions 182 that engage and ride along the toothed guide rails 176 of the guide track/first position adjustable mount 164. The second position adjustable mount 170 takes the form of a guide track that may be fixed to the carriage 168.

In the embodiment illustrated in FIG. 7, the first guide track/position adjustable mount 164 extends into and out of the drawing figure toward and away from the viewer while the second guide track/position adjustable mount 170 extends from left to right in the drawing figure. Thus, the two guide tracks/position adjustable mounts are perpendicular to one another. The radiant heating element 174 is displaced along the second guide track/second position adjustable mount 170 across the carriage 168 by the second actuator 172 which may comprise a motor, drive shaft and pinions (not visible in the figure).

While the second position adjustable mount 170 illustrated in FIG. 7 comprises a guide track, it should be appreciated that the second position adjustable mount 170 on the carriage 168 may assume other configurations including, for example, that of a pivot hinge 18 as illustrated in FIGS. 1 and 2 or that of a ball joint 54 as illustrated in FIGS. 3a, 3b, 4a and 4b. In effect, the radiant heating assemblies 10, 30 and 40 illustrated in FIGS. 1, 2, 3 and 3b including the position adjustable mounts 12, 54 and actuators 16, 58, as well as biasing elements 36 where appropriate, could be substituted for the second guide track/position adjustable mount 170 and second actuator 172 and carried on the carriage 168 in the FIGS. 6 and 7 embodiments of this invention if desired.

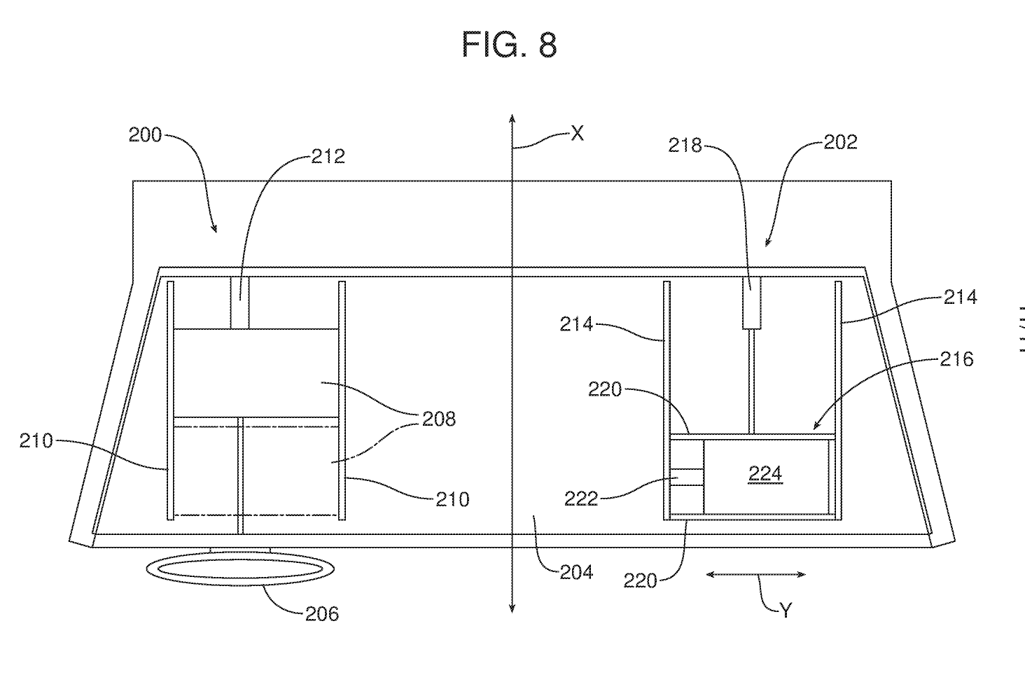

Reference is now made to FIG. 8 illustrating two radiant heating assemblies 200, 202 mounted along the top of an instrument panel 204 of a motor vehicle. The first radiant heating assembly 200 is positioned in front of the steering wheel 206 and includes a radiant heating panel 208 that is displaced between various operating positions along a position adjustable mount 210 in the form of a guide track that has a longitudinal axis parallel to the longitudinal axis X of the motor vehicle. A linear actuator 212 displaces the radiant heating panel 208 along the guide track/position adjustable mount 210. When the radiant heating panel is in the first operating position illustrated in full line in the drawing figure, infrared radiation from the panel is reflected off the overlying windshield onto the hands of the operator at the steering wheel 206. When the radiant heating panel 208 is displaced into the second operating position illustrated in phantom line in drawing FIG. 8 toward the steering wheel 206, the majority of the infrared radiation is reflected by the windshield onto the face and shoulders of the motor vehicle operator. The operator may adjust the position of the radiant heating panel 208 along the guide track/position adjustable mount 210 in order to focus the radiant heat generated by the radiant heating panel at the desired location.

The radiant heating assembly 202 includes a first position adjustable mount 214 in the form of a first guide track running parallel to the guide track/position adjustable mount 210 of the radiant heating assembly 200. A carriage 216 is displaceable along that first guide track/position adjustable mount 214 by means of the linear actuator 218. The radiant heating assembly 202 also includes a second position adjustable mount in the form of a second guide track 220 carried on the carriage 216. A second linear actuator 222 displaces the radiant heating panel 224 along the second guide track/second position adjustable mount 220 in a lateral direction corresponding to the Y axis of the motor vehicle. The resulting two degrees of freedom afforded for adjusting the position of the radiant heating panel 224 allows the passenger of the motor vehicle to better position and orient the panel for directing heat off the windshield onto the lower torso, upper torso and face of the passenger as desired. Here it should be appreciated that simple actuator switches including joysticks or touchscreen controls may be utilized by the driver and passenger to control the actuators and position the various heating panels of the radiant heating assemblies as desired.

The foregoing has been presented for purposes of illustration and description. It is not intended to be exhaustive or to limit the embodiments to the precise form disclosed. Obvious modifications and variations are possible in light of the above teachings. For example, FIG. 7 illustrates the placement of two radiant heating assemblies 200, 202 on the top of the instrument panel 204. Here it should be appreciated that the radiant heating assemblies may be positioned at various other locations throughout the motor vehicle including, for example, along the headliner, along the top of the package tray behind the rear seat and below the rear window, along the various trim panels of the motor vehicle including door trim panels, center console trim panels, and pillar trim panels, along the bottom of the seat fronts, along the seat backs and the sides and rear of the head rests, in the center console, the center stack or at other locations including in and around the foot wells and along the floor.

In FIG. 8, the second guide track 220 extends perpendicular to the first guide track 214. Here it should be appreciated that other angular orientations are contemplated so long as the second guide track is aparallel to the first guide track. Further, it should be appreciated that in certain embodiments for certain applications, the biasing elements and/or actuators for the radiant heating assembly may be incorporated into the position adjustable mount/hinge.

Still further, it should be appreciated that the cable and pulley device 150 of FIG. 5c may be replaced with a smart material alloy wire. In still other embodiments, the position adjustable mount and actuator will allow for manual movement of the radiant heating element. In still other embodiments, the actuator may be deleted from the assembly and the position adjustable mount would then allow for only manual movement of the radiant heating element. All such modifications and variations are within the scope of the appended claims when interpreted in accordance with the breadth to which they are fairly, legally and equitably entitled.

What is claimed:

1. A radiant heating assembly, comprising:
a position adjustable mount;
a radiant heating element carried on said position adjustable mount; and
an actuator to displace said radiant heating element between a first position and a second position.

2. The radiant heating assembly of claim 1, wherein said position adjustable mount is a hinge.

3. The radiant heating assembly of claim 2, wherein said actuator is a linear actuator.

4. The radiant heating assembly of claim 3, wherein said linear actuator is selected from a group consisting of a screw drive, a shape memory alloy (SMA) actuator, a dielectric elastomer, a solenoid actuator, a kinematic linkage assembly actuated by a solenoid, a pneumatic actuator and a hydraulic actuator.

5. The radiant heating assembly of claim 2, further including a biasing element biasing said radiant heating element toward said first position.

6. The radiant heating assembly of claim 5, wherein said biasing element is on a first side of said hinge and said actuator is on a second side of said hinge.

7. The radiant heating assembly of claim 1, wherein said position adjustable mount is a ball joint and said actuator includes a first actuator and a second actuator connected to said radiant heating element at two different connection points.

8. The radiant heating assembly of claim 7, further including a first biasing element and a second biasing element, said first biasing element, said ball joint and said first actuator defining a first axis and said second biasing element, said ball joint and said second actuator defining a second axis.

9. The radiant heating assembly of claim 8, wherein said first axis is perpendicular to said second axis.

10. The radiant heating assembly of claim 9, wherein said first actuator and said second actuator are selected from a group consisting of a linear actuator, a cable and pulley, a hydraulic actuator, a pneumatic actuator, a screw drive, a shape memory alloy (SMA) actuator, a solenoid actuator, a kinematic linkage assembly actuated by a solenoid and combinations thereof.

11. The radiant heating assembly of claim 1, wherein said position adjustable mount is a first guide track.

12. The radiant heating assembly of claim 11, wherein said actuator is a linear actuator.

13. The radiant heating assembly of claim 12, further including a biasing element biasing said radiant heating element toward said first position.

14. The radiant heating assembly of claim 11, further including a carriage riding on said first guide track.

15. The radiant heating assembly of claim 14, further including a second position adjustable mount displaceable along said first guide track with said carriage.

16. The radiant heating assembly of claim 15, further including a second actuator displaceable along said first guide track with said carriage and functioning with said actuator to displace said radiant heating element between said first position and said second position.

17. The radiant heating assembly of claim 16, wherein said second position adjustable mount is a second guide track extending aparallel to said first guide track and said second actuator displaces said radiant heating element along said second guide track.

18. The radiant heating assembly of claim 16, wherein said second position adjustable mount is a hinge and said second actuator displaces said radiant heating element about said hinge.

19. The radiant heating assembly of claim 16, wherein said second position adjustable mount is a ball joint and said second actuator displaces said radiant heating element about said ball joint.

20. The radiant heating assembly of claim 1, wherein said radiant heating element is one of a radiant heating panel and a specular radiant heating surface.
